(19) United States
(12) Patent Application Publication
(10) Pub. No.: US 2001/0012812 A1
(43) Pub. Date: Aug. 9, 2001

(54) Strong lightweight panel element and apparatus for manufacturing the same

(76) Inventor: Ernst Maximilian Spengler, Heusenstamm (DE)

Correspondence Address: FASSE PATENT ATTORNEYS, P.A., P.O. BOX 726, HAMPDEN, ME, 04444-0726, US

(21) Appl. No.: 09/773,833

(22) Filed: Jan. 31, 2001

(30) Foreign Application Priority Data
Feb. 1, 2000 (DE) 200 01 729.2

(51) Int. Cl. B31B 7/00

(52) U.S. Cl. 493/100

(57) ABSTRACT

A form-stable panel element, such as an automobile ceiling headliner, includes two layers of pyramid frustum-shaped cups that are intermeshed with each other, and two cover layers that close and seal hollow chambers in each of the cups. Each chamber is filled with a filler material that may be a loose mixed granulate of waste or recycled polymer. All of the layers are thermally fused and laminated integrally together. The panel element may be molded into a three-dimensional contour. The panel element is strong, lightweight, stiff against bending, incorporates waste or recycled materials, and provides good noise damping.

### PRIORITY CLAIM

This application is based on and claims the priority under 35 U.S.C. §119 of German Utility Model Application 200 01 729.2, filed on Feb. 1, 2000, the entire disclosure of which is incorporated herein by reference.

### FIELD OF THE INVENTION

The invention relates to a multi-layered panel element that is substantially rigid and form-stable, yet light in weight, and suitable for use especially for trim and finish components, such as ceiling headliners, package shelves, trunk floors, wall panels, or the like within motor vehicles, or similar components of furniture and furnishings as well as wall panels or dividers for residential and commercial building construction. The sandwich-form panel element has a high bending stiffness and bending strength, and can be fabricated with simple processes. The invention further relates to an apparatus for manufacturing such a panel element.

### BACKGROUND INFORMATION

Various types of lightweight panel elements are known in the prior art. One general class of such panel elements has a so-called honeycomb core of open hexagonal cells, covered with two cover skins. While such honeycomb core panels are available, made of many different material combinations, for many different applications, they generally suffer certain common disadvantages. For example, such honeycomb panels are conventionally limited to flat planar panel elements, i.e. they cannot be formed or molded to three dimensionally contoured shapes as required for special applications. This is due to the limitations of the honeycomb core, and the manner in which it is manufactured.

Furthermore, while the honeycomb core provides a good stiffness and bending strength for the overall panel, the cover skins are merely adhesively bonded or brazed or similarly connected to the honeycomb core. If the bond between the cover skins and the honeycomb core fails, delamination of the panel is a serious risk. There is no interlocking connection provided between the cover skins. Instead, the honeycomb core and each cover skin must be regarded as respective separate components that are simply adhesively bonded or brazed to each other along flat planar contact surfaces.

Many different attempts have been made to improve the noise damping of the above mentioned honeycomb core panel elements, and in general to provide effective noise damping within the cabin space of a motor vehicle. Only with special measures, e.g. forming tuned resonator cavities, or providing additional noise damping material layers, is an adequate noise damping achieved using the honeycomb core construction.

A further constant need in the motor vehicle manufacturing industry is the recycling or reuse of waste material that arises during the manufacturing of a particular motor vehicle itself, or from the scrapping of old motor vehicles. Proposed future regulations will require motor vehicle manufacturers to reuse at least 30% of recycled material in the total content of all interior trim components of passenger vehicles, for example. The recycling of previous scrap material, often including a mixture of various thermoplastic materials, thermoset materials, natural materials such as wood fibers, plant fibers, fabrics, leather, and the like, is generally associated with a high cost, if the materials need to be separated, and then separately reprocessed. In view of such costs for separately processing materials, a huge volume of mixed recycled or scrapped materials of almost undefinable content is constantly available in the motor vehicle manufacturing industry, and is generally being disposed of in various ways, which are no longer environmentally acceptable.

### SUMMARY OF THE INVENTION

In view of the above, it is an object of the invention to provide a panel element that achieves the advantages of a conventional honeycomb core panel element, while avoiding the disadvantages thereof, and particularly achieving a strong inter-locking or inter-bracing effect between the two sides of the panel element. It is a further object of the invention to simultaneously provide noise damping in such a panel element, while also incorporating readily available recycled or scrapped material of mixed content, without any special content requirement. The invention further aims to avoid or overcome the disadvantages of the prior art, and to achieve additional advantages, as apparent from the present specification.

The above objects have been achieved according to the invention in a strong lightweight panel element that comprises a stack or layered arrangement of a first cover layer, a first layer of tapered cup members, a second layer of tapered cup members, and a second cover layer. The two respective layers of tapered cup members are respectively oriented to taper in opposite directions so that the tapered cup members of the second layer are respectively arranged between and intermeshing with the tapered cup members of the first layer. Each respective cup member is formed by a protrusion forming the outside of the cup on one side of the layer, and a corresponding recess or depression forming the inside of the cup on the other side of the layer.

Due to the intermeshing and interlocking arrangement of the respective cup members of the first layer and of the second layer, there is a strong mechanical connection and bracing achieved between the two respective layers on opposite sides or opposite surfaces of the panel element. The interlocking effect is almost like interlocking gear teeth or the interlocking teeth of a zipper, whereby the first cup members and second cup members are braced against one another in a force transmitting manner. This interlocking or intermeshing is repeated through the uniform intermeshing pattern of the respective cup members in two dimensions, i.e. across the entire width and length of the panel element. Also, the respective layers are thermally fused and bonded to each other along the significantly increased surface area of overlapping contact surfaces of the intermeshing cup members. This effect significantly increases the strength and bending stiffness of the finished panel element to a surprising degree.

Moreover, due to the variable intermeshing that can be achieved with the tapering configuration of the cup members, and depending on the particular chosen shape of the cup members, the panel element is not limited to a flat planar configuration, but rather may be formed or molded into three dimensional contours as needed for any particular application. Namely, the arrangement of the cup members allows for differing degrees of intermeshing of the respective cup members into the tapering spaces of the opposite facing layer of cup members, and also allows flexing and forming of the respective cup member layer during the fabrication process. While the panel element is being fabricated, under the influence of heat and molding pressure, the materials of the panel element remain deformable and yielding, so that each respective cup member yields or deforms to a varying degree depending on the molding needs at that particular location.

Advantageously, the first and second cover layers entirely close or seal the respective open sides of the cup member layers. Thus, the respective cup member layer together with the adjoining cover layer form a plurality of completely closed or encapsulated hollow cup chambers. These enclosed or sealed cup chambers of at least one of the cup member layers may contain almost any desired filler material, which preferably is a filler material providing noise damping qualities. A particularly suitable material in this context is a mixed granulate and/or mixed fiber material of scrapped or recycled materials of mixed content, for example comprising various thermoplastic and thermoset polymer components in the form of mixed granules, fibers, dust, etc. Since each cup chamber is entirely encapsulated and sealed, it is irrelevant and unknown to the outside observer what materials are contained within the chamber of each cup member.

On the one hand, this provides an excellent opportunity for incorporating and thereby disposing of otherwise unusable mixed scrap material. On the other hand, the material may be selected from among any available materials at the time of manufacturing the respective panel element, so as to achieve the required degree of noise damping, thermal insulation, and mechanical strengthening. In other words, essentially any type of material or mixed material can be filled into the cup chambers, as long as it provides the required noise damping (and other) characteristics. Thus, it is not necessary to always continuously provide the same filler material when manufacturing a series production of the panel element.

Furthermore, the filler material that substantially fills out the interior space or chamber within each cup member serves to mechanically support and brace the cup walls of the respective cup member. In this manner, a crushing or collapsing of the cup members is prevented, which further contributes to the strength and stiffness of the finished panel, as well as the moldability or formability thereof during the manufacturing process.

The panel element is preferably manufactured in a continuous flow-through process, from continuous or long webs of raw sheet materials, which preferably contain at least a proportion of a thermoplastic synthetic material. Such a content of thermoplastic synthetic material gives the sheet or web materials the required degree of deformability and thermal welding properties, to allow the cup members of the cup member layers to be formed, the cover layers to be thermally welded onto the cup member layers, and the cup member layers to be intermeshed and thermally fused and interbonded with each other, while ultimately also allowing the laminated structure of the panel element to be molded with a required three-dimensional contour. All of these steps are achieved by appropriate thermal heating, molding under pressure, and subsequent cooling so as to solidify and rigidify the respective layers.

### BRIEF DESCRIPTION OF THE DRAWINGS

In order that the invention may be clearly understood, it will now be described in connection with example embodiments, with reference to the accompanying drawings, wherein:

FIG. 1 is a perspective schematic illustration of a panel element according to the present invention, having a flat planar configuration;

FIG. 2 is an enlarged detailed view of a profiled or molded cup member layer in a side view;

FIG. 3 is a view corresponding to FIG. 2, but additionally showing a cover layer;

FIG. 4 is a schematic side view of the layered or stacked structure of a panel element according to the invention, with two cup member layers intermeshing with one another, and sandwiched between two outer cover layers, whereby the layers are differentially broken away for the sake of illustration;

FIG. 5 is a broken-away top view of the arrangement shown in FIG. 4;

FIG. 6 is a sectional view of essentially the structure shown in FIG. 4, but with the two cup member layers exploded apart or shown before the step of intermeshing these two layers;

FIG. 7 is a side view generally corresponding to FIG. 4, but showing an embodiment with four-sided pyramid frustums rather than conical frustums as the cup members;

FIG. 7′ is a side view similar to that of FIG. 7, but showing a further embodiment in which the four-sided pyramid frustums of the cup members are arranged directly adjoining one another in continuous parallel rows thereof, in contrast to the embodiment of FIG. 7 in which the cup members are all spaced apart from one another in the rows and columns;

FIG. 8 is a top view corresponding to FIG. 5 but for the embodiment of FIG. 7;

FIG. 8′ is a top view corresponding to FIG. 8, but for the embodiment of FIG. 7′;

FIG. 9 is an exploded or separated side view corresponding to FIG. 6, but showing the embodiment of FIG. 7;

FIG. 9′ is an exploded or separated side view corresponding to FIG. 9, but showing the embodiment of FIG. 7′;

FIG. 10 is a side view generally corresponding to that of FIG. 4, but showing an embodiment with hexagonal polygon pyramid frustums as the cup members;

FIG. 11 is a top view corresponding to FIG. 5, but showing the embodiment of FIG. 10;

FIG. 12 is an exploded or separated side view corresponding to FIG. 6, but showing the embodiment of FIG. 10;

FIG. 13 is a schematic diagram showing the principle components of an apparatus for manufacturing a profiled or cupped material web for use in manufacturing the panel element according to the invention;

FIG. 14 is a schematic diagram showing the principle components of an apparatus for combining and bonding together two profiled material webs with additional material webs for forming cover layers, so as to fabricate the panel element according to the invention;

FIG. 15 is an enlarged detail sectional view of a broken portion of a cup member layer with a cover layer forming cup chambers that are filled with a filler material;

FIG. 16 is a schematic diagram showing the principle components of the apparatus for forming a profiled material web as the cup member layer, with the cup chambers filled with a filler material and closed by a cover layer; and

FIG. 17 is a schematic diagram generally corresponding to FIG. 16, but further together with an arrangement for separating individual elements from the profiled material web having the filled, closed cup chambers.

### DETAILED DESCRIPTION OF PREFERRED EXAMPLE EMBODIMENTS AND OF THE BEST MODE OF THE INVENTION

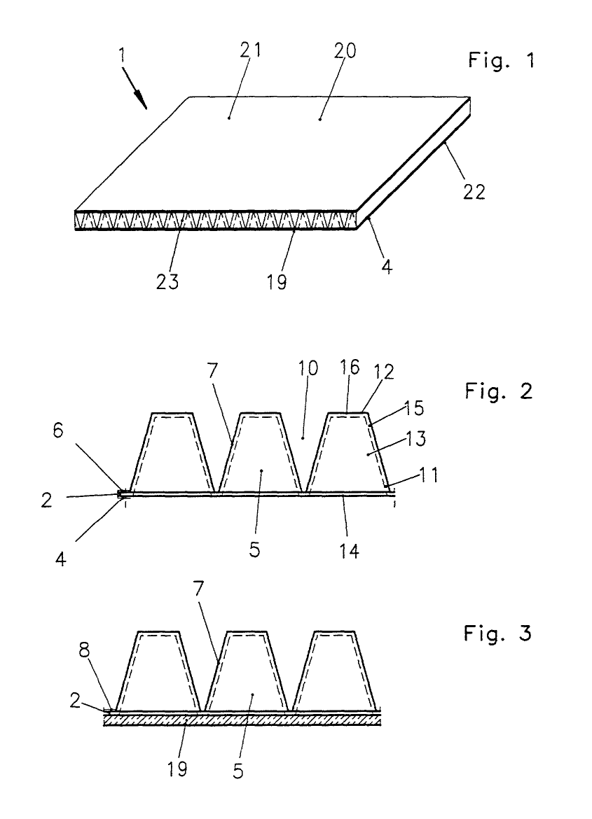

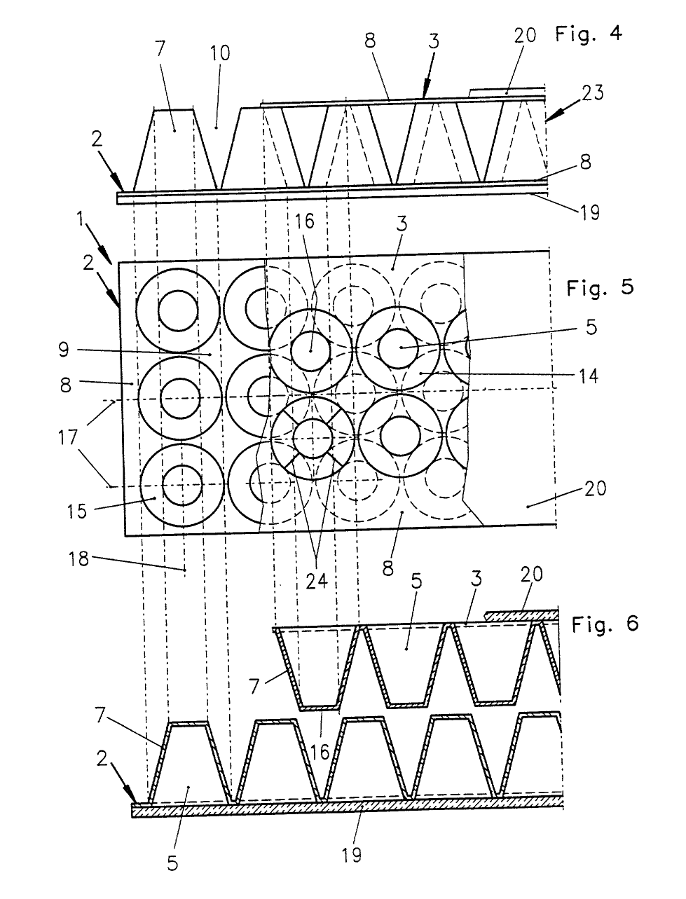

A multi-layered panel element 1 according to the invention, and particularly the embodiments shown in FIGS. 1 to 6, comprises a first profiled cup member layer 2 and a second similarly profiled cup member layer 3. Preferably, these two layers 2 and 3 are each configured the same as one another. In the present example embodiment this is the case, so the details of both layers will predominantly be discussed with reference to the layer 2 as shown in FIGS. 2 and 3, whereby it is understood that the layer 3 has the same features.

The two layers 2 and 3 each comprise depressions or recesses 5 that form hollow concave bowls or cups on one side 4 of the respective layer, and corresponding protrusions 7 on the other side 6 of the respective layer, whereby these protrusions 5 form the outer or convex side of the respective cups. Along the edges or rims 8 thereof, and in areas between the depressions 5 and between the protrusions 7, the two layers 2 and 3 include flat planar areas, which still represent the flat planar base sheet from which the profiled layer 2 or 3 was formed. Namely, respective flat planar intermediate parts 9 of the layers 2 and 3 are located at these flat areas, for example as shown in FIG. 5. The intermediate parts 9 connect together the respective walls forming the cup members respectively of the protrusions 7 and the corresponding depressions 5. While the present embodiment has these flat intermediate parts 9 at certain locations between the bases of all of the cup members, other embodiments (as described below) have the bases of adjacent cup members directly adjoining one another in at least some directions, i.e. without any flat planar intermediate parts therebetween. Between the protrusions 7 forming the cup members, there are free open intermediate spaces 10.

In the first representative embodiment shown in FIGS. 1 to 6, the cup members or protrusions 7 each respectively have a conical frustum shape, tapering from a base end 11 to the free protruding end 12. The depressions 5 respectively on the opposite side or the inside of the cup members or protrusions 7 respectively form hollow bowls or chambers 13 therein, and have an opening 14 on the base end 11. The cup member is respectively formed or bounded so as to surround the open hollow chamber 13 of the depression 5, by a side wall 15 and an end wall 16 on the free end 12. The open cross-section of the opening 14 is considerably larger than the surface area of the end wall 16, so that it is clear that the side wall 15 extends at an angle relative to the flat side 4 of the layer 2 or 3. On the other hand, the end walls 16 lie on a plane parallel to the side 4 of the layer 2 or 3. The cup members or protrusions 7 may be spaced slightly apart from one another, or may be in direct adjoining contact with one another with parallel rows 17 and columns 18 perpendicularly to the rows 17, along their respective base ends 11. While FIG. 5 shows a slight gap between respective adjacent cup members, the cup members could alternatively be directly joined at the edges thereof on the base ends 11.

In order to close the openings 14 of the cup members, the panel element 1 further comprises two respective cover layers 19 and 20 respectively allocated to and laminated onto the cup member layers 2 and 3. Thereby, the cover layers 19 and 20 completely seal and close the hollow chambers 13 within the cup members, but simultaneously also provide closed finished surfaces 21 and 22 on the top and bottom sides of the panel element 1 according to FIG. 1. For example, these surfaces 21 and 22 are flat planar surfaces. The cover layers 19 and 20 also significantly contribute to the bending stiffness and strength, and the high self-supporting stability of the panel element 1 by the effect of closing or covering the openings 14 of the chambers 13 of the two cup member layers 2 and 3.

In the finished panel element 1, the two cup member layers 2 and 3 together form a profiled core layer 23 as shown in FIG. 1, for example. In this context, the layers 2 and 3 are oriented with their respective cup-shaped protrusions 7 facing toward and offset by one half pitch relative to the cup-shaped protrusions 7 of the other layer, in such a manner that the protrusions 7 respectively intermesh with one another. In this arrangement, a respective cup-shaped protrusion 7 of one layer is located in the free interspace 10 between four adjoining cup-shaped protrusions 7 of the other layer (see FIG. 5).

In the finished plate element 1, the layers 2 and 3 are not merely in touching contact with one another along the respective protrusions 7, but rather, the layers 2 and 3 are directly connected with one another due to the fabrication process that will be described below. Namely, the intermeshing cup-shaped protrusions 7 are interlocked or engaged with one another mechanically by the interlocking shapes thereof, but also the materials of the respective layers are integrally bonded to each other. In the embodiment with the conical frustum-shaped protrusions 7, these direct connections are formed along straight contact lines 24 where the conical side walls 15 of respective adjacent cup-shaped protrusions 7 contact each other, as shown in FIG. 5, as well as along the end walls 16 that are directly in contact with the intermediate parts 9 of the respective opposite layer's base sheet.

FIG. 5 shows only a small portion of a generally strip-shaped panel element 1. It should be understood, however, that such elements 1 can have essentially any desired or required length and width, in combination with a respective required thickness, for example in a range from about 5 mm to about 50 mm. Regardless of the required sizes, all of the cup-shaped protrusions 7 of one layer 2 are intermeshed with the cup-shaped protrusions 7 of the other layer 3 across the entire surface dimensions thereof, while forming an interlocked profiled core layer 23. It is further to be understood in this context, that the cup-shaped protrusions 7 and the free interspaces 10 therebetween are respectively dimensioned in a matched or mutually adapted manner, in order to achieve a surfacial or at least linear contact between the two layers 2 and 3 as described above.

The cup-shaped protrusions 7 may have different forms, i.e. are not required to have a conical frustum shape with a circular cross-section as shown in FIGS. 4 to 6. Particularly, they may alternatively have a polygon cross-sectional shape, or may have any such specialized shape so as to completely fill out the free interspaces 10 in a form-filling and form-interlocking manner. It should further be understood, for example in the latter case, that the protrusions of the two respective layers 2 and 3 do not need to be identical in form, but instead can have respective different forms to achieve the form-locking intermeshing as mentioned.

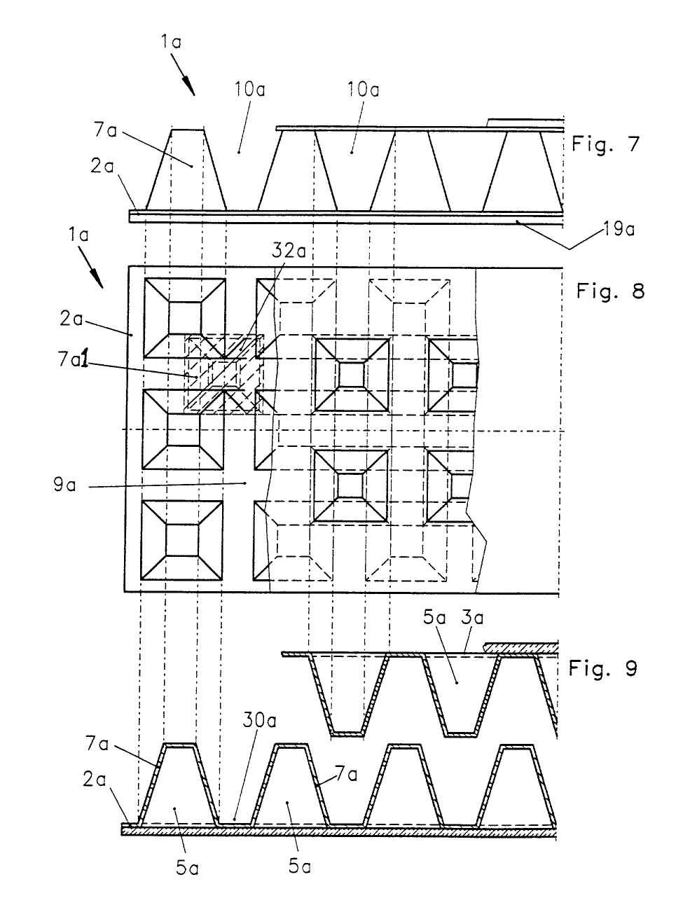

Preferably, the cup-shaped protrusions of each respective layer are arranged directly adjoining one another at their respective base ends 11. This achieves the greatest strength, stiffness, and rigidity, in view of the direct force-transmitting and bracing connection among the cup-shaped protrusions 7. A base sheet can still be considered to exist at the junction areas at which the base edges of the adjacent protrusions adjoin each other. Alternatively, however, it is not absolutely necessary that all of the protrusions 7 must be directly adjoining one another along the base ends 11 in this manner. Such an alternative embodiment, which is completely adequate for many applications, is shown in FIGS. 7 to 9, in which generally the same components as in the above described Figures have the same reference numbers as used above, except additionally identified by the letter suffix or index a.

In this embodiment of FIGS. 7 to 9, the cup-shaped protrusions 7a of the panel element 1a each have a four-sided pyramid frustum shape, whereby the respective protrusions 7a are spaced apart from one another in two dimensions or directions by a clear spacing distance 30a between the respective base ends thereof. Flat intermediate parts 9a of the respective layers are provided between the neighboring protrusions 7a, and free interspaces 10a are respectively formed above the flat intermediate parts 9a between the respective protrusions 7a, as shown in FIG. 7.

Depending on the dimensions of the spacing distances 30A between neighboring ones of the protrusions 7A, and depending on the respective dimensions of the protrusions, the protrusions 7A of two laminated layers 2A and 3A will overlap and be in contact with one another along their corner edge areas 31A, or more-or-less surfacially along almost the entire side face surfaces thereof. The respective cup members or protrusions 7a can thus be surfacially joined with one another along these overlapping and mutually contacting surface areas. The largest surface contact is possible when the pyramid frustum shaped protrusions 7 of the two adjoining layers 2 and 3 are respectively offset by one half pitch of the protrusion spacing. This is illustrated in FIG. 8 by a representative protrusion 7al that belongs to the layer 3a and is shown with dashed shading.

A further embodiment using square-based pyramid frustum-shaped protrusions is shown in FIGS. 7′, 8′ and 9′, whereby the protrusions 7a′ are arranged directly butted against one another and in direct adjoining contact with one another along their respective bases, in at least one direction, e.g. in several rows, while the columns thereof may still be spaced apart with respective spacing distances between successive ones of the protrusions 7a′.

A finished panel element 1a with pyramid frustum-shaped protrusions 7a or 7a′ that are joined to each other along large surface areas, requires that the height, the base surface area, and the top surface area, as well as the dimensions and the slope angle of the side walls 32a thereof, are properly adapted or tuned to each other, to allow the required degree of intermeshing interpenetration of the protrusions of one layer respectively engaging between the protrusions of the other layer. The size of the contact surfaces is also a function of the larger or smaller spacing distances 30a between the respective protrusions. Thus, the desired degree of intermeshing can be achieved by appropriately adjusting the dimensional parameters of the protrusions.

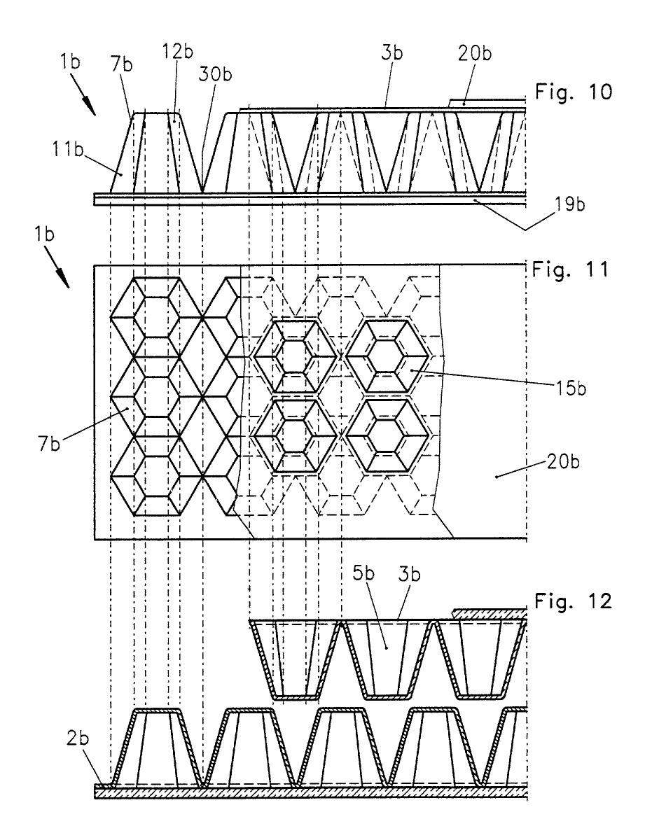

A further embodiment of a multilayer panel element 1b according to the invention is shown in FIGS. 10 to 12, whereby generally the same components as discussed above will be identified with the same reference numbers as used above, except additionally bearing the letter index or suffix b. The cup-shaped protrusions 7b of the element 1b have a polygon-shaped cross-section, and particularly a hexagonal cross-section which tapers in the manner of a hexagonal pyramid frustum from the base end 11b to the free end 12b. The spacing distance 30b between adjacent protrusions 7b on each of the two layers 2b and 3b is zero. The respective protrusions 7b of the two layers 2b and 3b are intermeshed and engaged with one another to form a single intermeshed layer as shown in FIG. 11. The side walls 15b of adjacent protrusions 7b of the opposite layers 2b and 3b are in surfacial contact with one another, and are thereby bonded or joined with one another due to the manufacturing process thereof, which will be described below.

As a further alternative, eight-sided or octagon-shaped protrusions may be provided. Such polygon-shaped tapering protrusions are advantageous, especially as shown for the hexagonal configuration in FIG. 11, because they achieve a good intermeshing or interlocking arrangement while filling out all (or at least most) of the available space between the respective protrusions of the opposite layer. The protrusions of the respective mutually opposite layers may be embodied or configured identically or at least similarly as each other. Alternatively, the protrusions of one layer can have a configuration different from the protrusions of the other layer, if this is required or advantageous to achieve an entire or substantial surfacial overlap between the opposite protrusions. By maximizing the surfacial overlap or contact, and thereby the interbonding between the two cup member layers, the strength and stiffness of the finished panel element is further improved and optimized.

As mentioned above, the strongest and stiffest arrangement can be achieved when the protrusions of each respective layer are directly adjoining one another at the base ends thereof. Also, as will be described further below, the strength as well as the noise damping characteristics of the finished panel element can be improved by filling the hollow chambers of the cup-shaped protrusions with an appropriate filler material, before sealing closed the filled chambers with the respective cover layers.

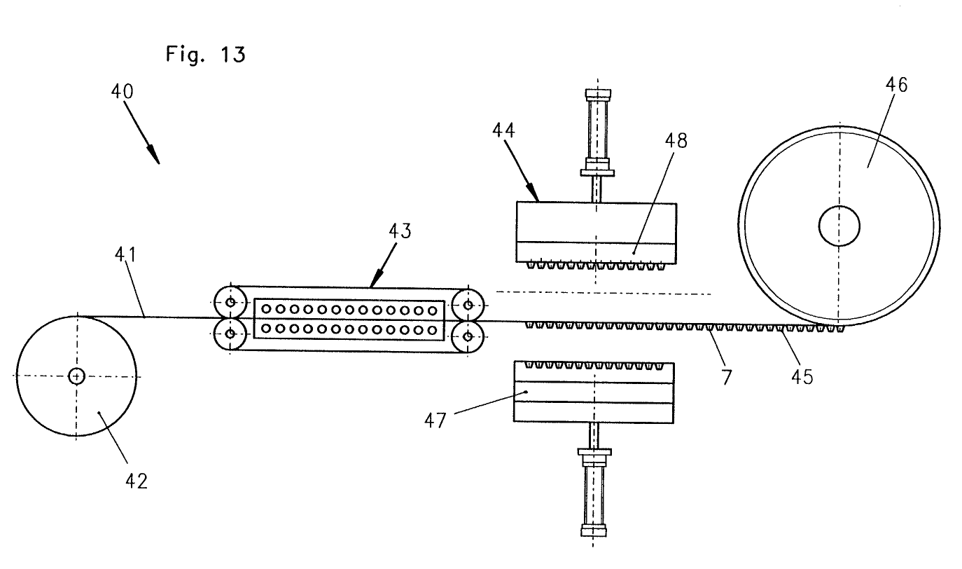

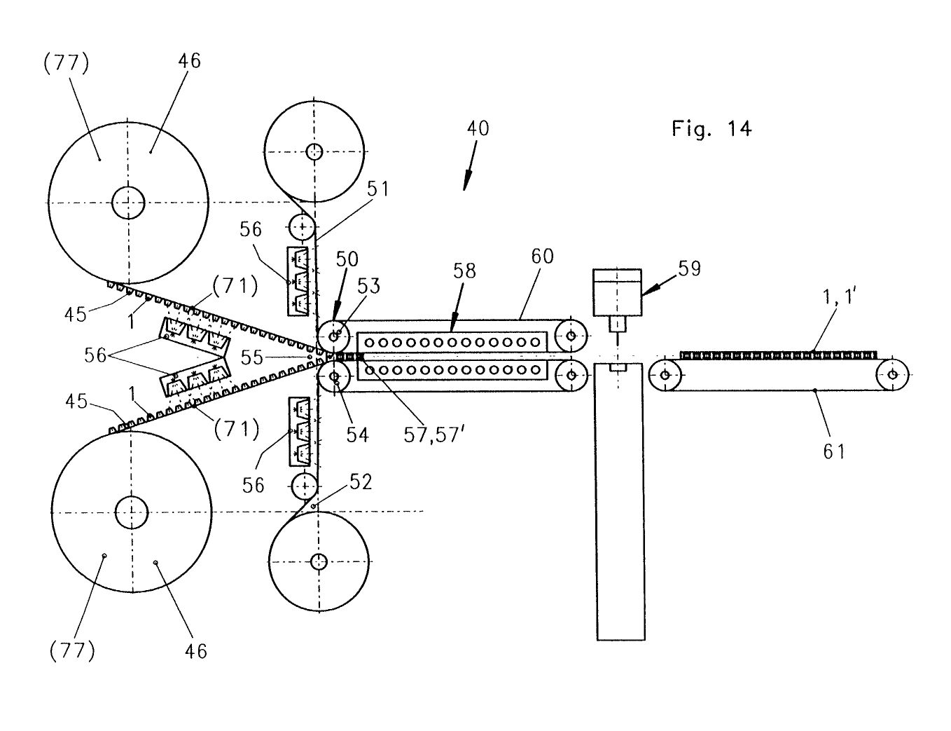

The production of the panel elements according to the invention will now be described with reference to a single panel element 1, in connection with the method steps and the schematically illustrated apparatus 40 as shown in FIGS. 13 and 14. Certain individual components or devices of the overall apparatus 40 are shown in FIG. 13, while other components or devices thereof are shown in FIG. 14.

A web-shaped material 41, which may be a fleece such as an oriented fleece or a random laid non-woven fleece, is provided as the raw starting material for forming the two layers 2 and 3 that will form the intermeshed core layer 23. This raw material fleece may be in the form of a non-woven mat, or alternatively may be a needled fleece, and in any event preferably contains synthetic thermoplastic fibers, for example mixed with other fibers, preferably including natural fibers.

The web-shaped starting material 41 is provided from a roll 42 into the apparatus 40, and particularly first into a heater arrangement 43, in which the material 41 is heated to the necessary temperature to soften and at least partially melt the thermoplastic fibers in the material 41. From the heating arrangement 43, the heated material 41 is transported into a forming station 44, in which the material 41 is compressed, densified, and also formed into the configuration with numerous cup-shaped protrusions held together by the continuous intermediate parts of the base sheet of the material web. Thereafter, the material is cooled, so that the profiled configuration of the now-cup-shaped material web 45 is set or fixed with this profiled configuration and can be further rolled onto an output take-off roll 46 for storage and supply to the further process steps.

In the present example embodiment, the forming station 44 comprises a lower mold tool 47 and an upper mold tool 48, between which the heated web-shaped material 41 is stamped, and molded to be profiled with the above-described depressions and protrusions forming the cup members of the respective layers 2 and 3. Particularly, each of the layers 2 and 3 is individually formed in the presently described manner. It is a simple matter to manufacture panel elements 1a or 1b or any other panel elements with cup-shaped protrusions 7 and depressions 5 having essentially any desired configuration, including such panel elements of which the protrusions of the two layers 2 and 3 respectively have different shapes, by providing the appropriate mold contours for the respective lower mold tool 47 and the upper mold tool 48 of the molding station 44. Using any conventionally known molding process and equipment, it is a simple operation to mold the initial flat sheet or web of starting material into the desired profiled contour, e.g. resembling a so-called egg-carton contour with the depressions and protrusions as described above.

FIG. 14 shows further features of the apparatus 40, namely a core layer laminating station 50 in which two profiled material webs 45, which have previously been profiled as shown in FIG. 13 to include the depressions and protrusions, are then guided together and engaged or intermeshed with one another in the manner of a multi-dimensional zipper to form the intermeshing core layer 23. The details of this process will be described below, but first it should be mentioned that the station 50 also provides two additional material webs 51 and 52 from opposite directions, to be laminated onto the respective opposite outwardly facing surfaces of the material webs 45, to form the outer cover layers thereon.

In the schematic illustration of FIG. 14, the laminating station 50 comprises two guide rollers 53 and 54, which are arranged with a roller gap 55 therebetween. It is in and through this roller gap 55 that the two profiled material webs 45, and the two cover layer material webs 51 and 52 are guided and then laminated together. However, before the material webs 45, 51 and 52 reach the roller gap 55, they are heated to the required degree using heater arrangements 56, so as to soften or even partially melt the thermoplastic synthetic material proportion of at least the material webs 45, and preferably also of the material webs 51 and 52. The softened thermoplastic materials will then be thermally welded or fused to each other as the respective material webs 45, 51 and 52 pass through the roller gap 55 while being pressed into laminated contact with each other therethrough. In this manner, downstream of the roller gap 55, the material webs 45, 51 and 52 form a unitary laminated multi-layer web-shaped workpiece 57, which is then cooled in a cooling arrangement 58 arranged downstream of the guide rollers 53 and 54.

Thereby, the two profiled material webs 45 have been intermeshed with each other, namely with the cup-shaped protrusions thereof intermeshing in the manner of a multi-dimensional zipper. Due to the preheating of the profiled material webs 45, the contacting surfaces of the intermeshing protrusions become fused to each other, and the cover layer materials 51 and 52 become fused onto the profiled material layers 45. Then this laminated, interbonded configuration is fixed by cooling in the cooler arrangement 58, e.g. comprising water-cooled contact platens or the like, or a water cooled conveyor device 60.

In the production flow direction downstream from the cooler arrangement 58, a stamping or cutting apparatus 59 is arranged, by means of which the sufficiently cooled workpiece 57 is then cut into individual panel elements 1, 1′ of the desired dimensions. A transport conveyor 60 transports the workpiece 57 through the cooler arrangement 58 to the stamping or cutting apparatus 59. A further transport conveyor 61 can be provided to transport the cut elements 1 away from the cutting apparatus 59.

Instead of cooling the laminated material layers, i.e. the workpiece 57, directly after it exits from the roller gap 55, the still-hot workpiece could be directed into a hot forming mold, in which the workpiece is pressed and molded to give it a required three-dimensionally contoured configuration, rather than the flat planar configuration that is schematically illustrated in the drawings. As a further alternative, the rollers 53 and 54 may be merely guide rollers, to bring together the four material layers into a hot forming and laminating press, without carrying out the function of laminating or pressing rollers. That, of course, just depends on the adjusted size of the roller gap 55 relative to the thickness of the materials. In such a case, the pressing, fusing and laminating would all be carried out in the hot forming mold.

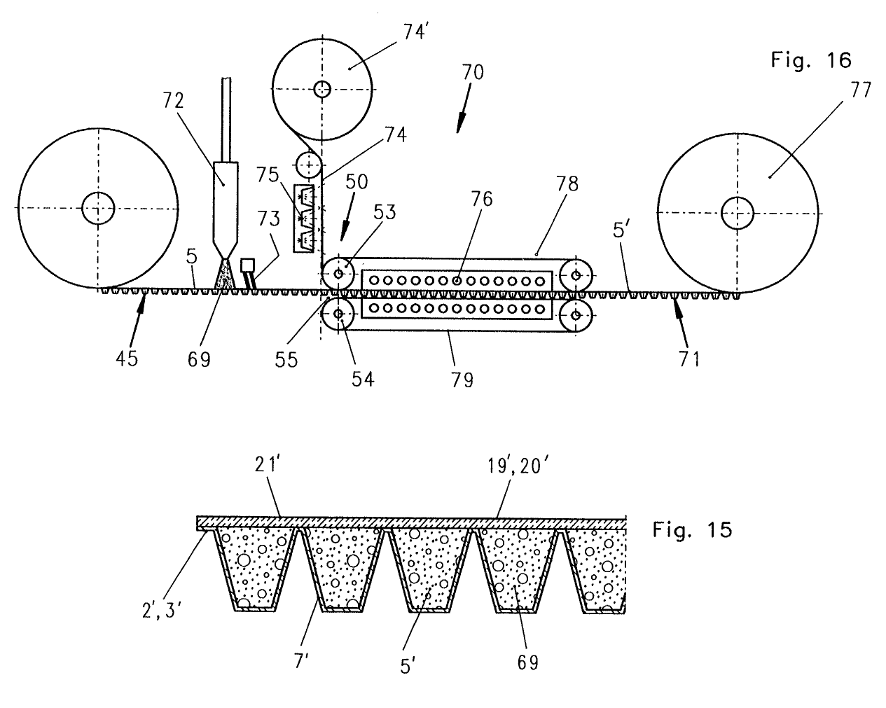

In the above described example embodiments of the panel elements 1, the cup-shape depressions 5 are each hollow and empty, or actually filled with air. A further aspect of the invention provides the panel element with added insulation against the passage of heat and cold through the panel element, as well as noise absorption or noise damping. To achieve this, the depressions 5′ of at least one of the layers 2′ or 3′, and preferably both of the layers 2′ and 3′ are filled with a filler material 69, before the depressions 5′ are closed and sealed with the cover layers 19′ and 20′, as shown in FIG. 15. Thus, each cup-shaped protrusion 7′ together with the respective cover sheet 19′ or 20′ forms a fully sealed or encapsulated cup chamber that is either partially or entirely filled with the filler material 69.

The filler material 69 may be a loose granulate, such as a mixed granulate of waste or recycled plastics, including both thermoplastic and thermoset materials, or ground fiber wastes, such as synthetic plastic fibers or ground particles of composite materials, or wood fibers, plant fibers, sawdust, and the like. Another alternative for the filler material 69 is a foaming synthetic such as a resin that is initially in liquid form, but forms an expanded foam that may either rigidify or remain soft and deformable in its finished condition. In any event, the filler material 69 is selected depending on the required degree of thermal insulation, noise insulation and noise damping, the presently available supply of different waste or recycled materials, and the degree of mechanical strengthening that is required in the panel element. Namely, the filler material 69 filling out the hollow chamber of each cup-shaped protrusion provides significant additional strength to the finished panel element, because it supports the walls of the cup-shaped protrusions and thereby prevents crushing or collapsing thereof. Even if the protrusion walls are slightly crushed or deformed during the intermeshing of the cup member layers, or during the contouring or molding of the panel element, a complete crushing and collapse of the cup-shaped protrusions is prevented by the filler material 69 encapsulated therein.

FIG. 16 shows an apparatus 70 for manufacturing a material web 71 with a filler material 69 filling the cup-shaped depressions 5′. As a starting material, the profiled material web 45, which has been formed with cup-shaped depressions 5 using the apparatus 40 according to FIG. 13, is supplied to the apparatus 70 of FIG. 16. In this apparatus 70, the cup-shaped depressions 5 will be filled with the filler material 69 by means of the filler device 72, which may be a simple granular material spreader trough or the like. A scraper or striker blade 73 is arranged downstream from the filling device 72 in the transport direction. From there, the material web 45 with the depressions 5′ filled with the filler material 69, is conveyed to a laminating station 50, in which this filled profiled material web 45 is laminated together with a material web 74 forming a cover layer to close the cup-shaped depressions 5′. The cover layer material web 74 is supplied from a roll of material 74′, and passes by a heating arrangement 75 to at least soften or partially melt the material web 74 before it is joined onto the profiled material web 45 in the laminating station 50.

Similarly as described above, the laminating station 50 comprises two guide rollers or laminating rollers 53 and 54 with a roller gap 55 therebetween. As the hot cover layer material web 74 and the filled profiled material web 45 pass through the roller gap 55, the two material layers are thermally fused onto each other, before being transported into a cooler arrangement 76. In this cooler arrangement 76, the thermally fused thermoplastic materials of the two material webs 45 and 74 are cooled so that the respective layers become permanently and securely fixed to each other. The bond between the layers is essentially an integral thermal fusion or hot-melt adhesion of the compatible plastic materials of the two webs to form a unitary laminated material web 71 that exits from the cooler arrangement 76. The cup-shaped depressions 5′ of the material web 71 are filled with the filler material 69 and are completely enclosed or encapsulated. This material web 71 is then rolled-up on a take-off roll 77.

Two of such rolls 77 of the sealed, laminated, profiled material webs 71 having the cup-shaped depressions filled with a filler material 69 are provided instead of the two rolls 46 into the apparatus 40 according to FIG. 14 for manufacturing a panel element from the material webs 71. However, since the cup-shaped depressions 5′ in the material webs 71, which have been filled with the material 69, are already covered by respective cover layer material webs 74, it is not necessary to provide additional cover layer webs 51 and 52 into the laminating station 50. Instead, the pre-laminated material webs 71 are directly heated using the heating arrangements 56 before being transported into the laminating station 50, where the two material webs 71 are intermeshed with each other and thermally fused together before being transported into the cooler arrangement 58. After exiting from the cooler arrangement 58, the essentially integral fused, laminated web-shaped workpiece 57 can be cut into successive panel elements 1′ of desired dimensions using an appropriate stamping or cutting apparatus 59.

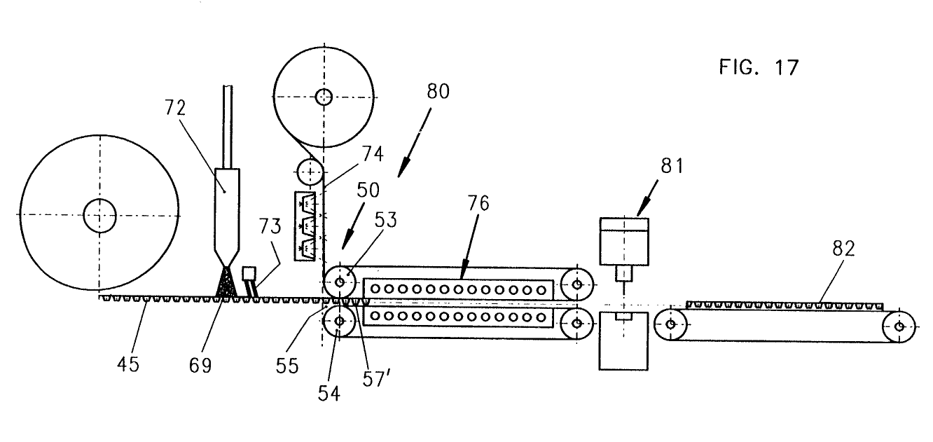

FIG. 17 shows another variation of the apparatus, namely an apparatus 80 which includes the filling device 72 similar to the apparatus 70 according to FIG. 16, with which a filler material 69 is filled into the cup-shaped depressions 5 of the material web 45. The apparatus 80 generally corresponds to the apparatus 70 described above with reference to FIG. 16, whereby the cover layer material web 74 is heated and delivered into the roller gap 55 to be pressed onto the profiled material web 45 of which the cup-shaped depressions have been filled with the filler material 69. One difference of the present apparatus 80 relative to the above described apparatus 70, is that the integrally laminated two-layer workpiece 57′, after exiting from the cooler arrangement 76, is transported to a stamping or cutting apparatus 81, which cuts the continuous web workpiece 57′ into individual pieces 82 of the desired length and width. In other words, here, the material has already been cut into precut blank pieces 82 while it still comprises only a single layer of the cup members laminated onto a single cover layer. Thereafter, two of the precut blank pieces 82 can be intermeshed with one another back-to-back so that the cup-shaped protrusions interengage, after being sufficiently heated, as described above, to prepare the finished panel element. Also as described above, the panel element may be three-dimensionally molded into any required contour using any conventional laminating and molding processes and equipment.

The invention is not limited to the use of particular starting raw materials for the various material webs. It is advantageous and preferred to make the profiled layers 2 and 3 of a material including polypropylene and/or polyethylene and/or polyester fibers and/or natural fibers, whereby a blend of 50% natural fibers and 50% polypropylene fibers is especially advantageous. The thermoplastic polypropylene fibers are suitable for achieving the thermal fusion or hot melt bonding of these layers 2 and 3 with each other and with the cover layer materials, and particularly any materials containing polyolefins or other plastic materials that are compatible for melt adhesion with polyolefins. Thus, it is also desirable that the cover layers contain at least a proportional content of a polyolefin. Alternatively, the cover layers may comprise a metal material, such as a thin aluminum foil or any of the known decorative cover materials conventionally used in motor vehicle interior trim components. It is further possible to use other metal foils or wood films or veneers on either one or both sides. Another alternative is to provide an armor layer or veneer layer respectively over the cover layers.

Among the above described various embodiments, an overall most preferred embodiment has the following features. The cup-shaped protrusions are preferably square, rectangular, hexagonal or octagonal in cross-section, and particularly in the form of pyramid frustums with such a cross-section, to achieve the best surfacial overlapping contact and bonding between the two cup member layers when the layers are intermeshed with one another. The cup-shaped protrusions are preferably directly adjoining one another along the base sides thereof, in at least one direction of rows or columns, and preferably in both directions of rows and columns, because such an arrangement provides the greatest force transmission and counter-bracing of the several cup-shaped protrusions against one another. Also, the cover layers are thermally fused onto the cup member layers, and the cup member layers are thermally fused with each other along the mutually contacting intermeshing surface areas thereof. There is no need to provide any additional adhesive for bonding the respective layers to each other. The sealed hollow chambers of the cup-shaped protrusions are preferably filled with a mixed loose filler material, such as a mixed granulate of thermoplastic and thermoset polymer waste or recycled material. The granulate filler material significantly increases the noise damping characteristic and the strength of the finished panel element.

The end result is a substantially integrally bonded, substantially rigid, form-stable panel element with an interlocked configuration of the cup-member layers with each other. Through-out this specification, the terms “substantially rigid” and “form-stable” indicate a degree of rigidity and form stability sufficient for a self-supporting trim panel such as a ceiling headliner in a motor vehicle.

The panel element may preferably be three-dimensionally contoured and molded, whereby the thermoplastic materials of the several layers simply stretch or yield where necessary. For example, on the outside or larger radius side of a curved contour, the base sheet of the cup member layer will simply stretch somewhat so that there are spaces respectively between the bases of the cup-shaped protrusions, while the base sheet of the cup member layer on the inside or smaller radius side of a curved contour will have the cup-shaped protrusions abutting directly against one another along the base edges thereof.

While the above embodiments of the panel element include only two of the cup member layers intermeshed with one another, it is alternatively possible to provide a greater number of the cup member layers, e.g. four of such layers respectively intermeshed pair-wise with one another.

Although the invention has been described with reference to specific example embodiments, it will be appreciated that it is intended to cover all modifications and equivalents within the scope of the appended claims. It should also be understood that the present disclosure includes all possible combinations of any individual features recited in any of the appended claims.

What is claimed is:

1. A panel element comprising:
a first cupped layer comprising a first base sheet and first cup-shaped protrusions protruding from one side of said first base sheet, wherein said first cup-shaped protrusions respectively taper away from said first base sheet, first free spaces are formed respectively between and around said first cup-shaped protrusions, and said first cup-shaped protrusions respectively have first hollow chambers therein;
a first cover layer laminated and thermally fused onto an opposite side of said first base sheet opposite said one side thereof, so as to close and seal said first hollow chambers;
a second cupped layer comprising a second base sheet and second cup-shaped protrusions protruding from one side of said second base sheet, wherein said second cup-shaped protrusions respectively taper away from said second base sheet, second free spaces are formed respectively between and around said second cup-shaped protrusions, and said second cup-shaped protrusions respectively have second hollow chambers therein; and
a second cover layer laminated and thermally fused onto an opposite side of said second base sheet opposite said one side thereof, so as to close and seal said second hollow chambers;
wherein said first cupped layer and said second cupped layer are arranged and laminated together with said first cup-shaped protrusions and said second cup-shaped protrusions intermeshed with each other, whereby said first cup-shaped protrusions are received in said second free spaces, said second cup-shaped protrusions are received in said first free spaces, and said first cup-shaped protrusions contact and are thermally fused with said second cup-shaped protrusions along intermeshing contact lines or surface areas of said respective protrusions.

2. The panel element according to claim 1, wherein said panel element has a flat planar configuration.

3. The panel element according to claim 1, wherein said panel element has a non-planar three-dimensionally contoured configuration.

4. The panel element according to claim 1, further comprising a filler material contained in at least said first hollow chambers or said second hollow chambers.

5. The panel element according to claim 4, wherein said first hollow chambers and said second hollow chambers are filled with said filler material.

6. The panel element according to claim 4, wherein said filler material comprises a mixed particulate material comprising plural different materials in particulate form.

7. The panel element according to claim 6, wherein said mixed particulate material comprises a mixed plastic granulate including thermoplastic and thermoset plastic waste or recycled materials.

8. The panel element according to claim 6, wherein said mixed particulate material comprises mixed fibers of different fibrous materials.

9. The panel element according to claim 4, wherein said filler material comprises a foamed synthetic plastic.

10. The panel element according to claim 4, wherein said filler material provides a better noise damping and a better thermal insulation for said panel element than said panel element has without said filler material.

11. The panel element according to claim 1, wherein said first cover layer is thermally fused directly onto said first cupped layer without any additional adhesive interposed therebetween, said first and second cupped layers are thermally fused directly to each other without any additional adhesive interposed therebetween, and said second cover layer is thermally fused directly onto said second cupped layer without any additional adhesive interposed therebetween.

12. The panel element according to claim 1, wherein said first cupped layer and said second cupped layer respectively consist of a material including a thermoplastic polymer.

13. The panel element according to claim 12, wherein said material is a composite material including said thermoplastic polymer.

14. The panel element according to claim 12, wherein said material further includes natural fibers.

15. The panel element according to claim 12, wherein said first and second cover layers respectively comprise a thermoplastic material.

16. The panel element according to claim 1, further comprising a third cupped layer and a fourth cupped layer that each include respective cupped protrusions protruding from a respective base sheet, and that are intermeshed with each other in the same manner as said first and second cupped layers, and wherein said third and fourth cupped layers are laminated and thermally bonded directly or indirectly onto one of said cover layers.

17. The panel element according to claim 1, wherein said first cup-shaped protrusions and said second cup-shaped protrusions each respectively have a conical frustum shape.

18. The panel element according to claim 1, wherein said first cup-shaped protrusions and said second cup-shaped protrusions each respectively have a pyramid frustum shape.

19. The panel element according to claim 1, wherein each one of said protrusions has a hexagonal cross-sectional shape.

20. The panel element according to claim 1, wherein each one of said protrusions has an octagonal cross-sectional shape.

21. The panel element according to claim 1, wherein respective adjacent ones of said first cup-shaped protrusions are directly adjoining one another without any space therebetween along base edges thereof on said first base sheet in at least one row direction, and wherein respective adjacent ones of said second cup-shaped protrusions are directly adjoining one another without any space therebetween along base edges thereof on said second base sheet in at least one row direction.

22. The panel element according to claim 21, wherein said adjacent ones of said first cup-shaped protrusions and said adjacent ones of said second cup-shaped protrusions are respectively directly adjoining one another in said row direction and in a column direction perpendicular to said row direction.
